(19) United States
(12) Patent Application Publication
(10) Pub. No.: US 2001/0055905 A1
(43) Pub. Date: Dec. 27, 2001

(54) TAB, probe card, TAB handler and method for measuring IC chip

(76) Inventor: Toshiyuki Tezuka, Tokyo (JP)

Correspondence Address: PILLSBURY WINTHROP LLP, 1600 TYSONS BOULEVARD, MCLEAN, VA, 22102, US

(21) Appl. No.: 09/741,112

(22) Filed: Dec. 21, 2000

(30) Foreign Application Priority Data
Dec. 22, 1999 (JP) 11-365158

(51) Int. Cl. H01R 3/00

(52) U.S. Cl. 439/488

(57) ABSTRACT

A TAB, a probe card, a TAB handler and a method for measuring an IC chip which are more efficient by detecting a positional relation between the probe card and the TAB before measuring an IC chip on the TAB. The TAB (10) comprises: an IC chip (1) formed on a tape-like film continuously; a test pad (4) connected to the IC chip through a lead electrically; a perforation (12) for moving the tape-like film; an alignment mark (3) for verifying a position of the test pad; and a pattern (5) for verifying a position of a probe card (9) on a TAB handler.

### BACKGROUND OF THE INVENTION

1. Field of the Invention

The present invention relates to a TAB (Tape Automated Bonding), a probe card, a TAB handler and a method for measuring an IC chip.

A TAB is generally termed a bonding system in which leads of conductor and corresponding portions of electrodes of an IC chip to the leads, which are formed on a tape-like film continuously are stacked and joined to connect a lot of wirings at the same time. However, according to the present invention, the TAB will be explained as a device produced in the bonding system.

2. Description of Related Art

According to an earlier development, a structure of a TAB and a probe card applied to a TAB handler will be explained with reference to FIG. 5 to FIG. 7.

First, the structure of the TAB and the probe card applied to the TAB handler will be explained, as follows.

FIG. 5 is a sectional view showing the structure of the TAB handler and the TAB 20 according to an earlier development. In more detail, according to the TAB 20, FIG. 5 is a sectional view taken substantially along the lines Y-Y′ of FIG. 7.

In FIG. 5, the TAB handler is composed of a pusher 2 and a probe card 18, and the TAB 20 is disposed between the pusher 2 and the probe card 18. The pusher 2 holds the TAB 20 and presses it against the probe card 18.

An IC chip 1 is mounted on a front surface of the TAB 20 and an alignment mark 3 and a plurality of test pads 4 (for example, the test pads 4A to 4D shown in FIG. 5) are formed on a rear surface of the TAB 20.

A measurement probe needle 6 (for example, measurement probe needles 6A to 6D shown in FIG. 5) as a needle to the TAB 20 is disposed at the probe card 18. In FIG. 5, free edge portions (portions at the side of the TAB 20 in FIG. 5) of the measurement probe needles 6A to 6D can be contacted with the test pads 4A to 4D, respectively. And fixed edge portions (portion at the side of the probe card 18 in FIG. 5) of the measurement probe needles 6A to 6D are held on the probe card 18 by a bonding block 17.

FIG. 6 is a plan view of the probe card 18 shown in FIG. 5. In FIG. 6, the measurement probe needles 6A to 6H are fixed on the probe card 18 by the bonding card 17. The measurement probe needles 6A to 6D are stood opposite to the measurement probe needles 6E to 6H, respectively. Under the free edge portions of the measurement probe needles 6A to 6H (an inside of the bonding card 17 shown in FIG. 6), an opening portion through which an image of the alignment mark 3 can be recognized is formed.

FIG. 7 is a plan view of the TAB 20 shown in FIG. 5. In FIG. 7, a plurality of perforations 12 which are geared into sprockets of the TAB handler, not shown in figures to move the TAB 20 horizontally, are equally spaced at both edges of the TAB 20. The sprockets of the TAB handler are disposed at both wings of the pusher 2 shown in FIG. 5 and geared into the perforations 12. The sprocket is driven, and thereby the TAB 20 is moved horizontally.

The IC chip 1 as a sample to be measured is disposed at a center position of the TAB 20. The test pads 4A to 4H are measurement pads to be contacted with the measurement probe needles 6A to 6H, respectively, when the IC chip 1 is measured. The IC chip 1 is connected to the test pads 4A to 4H through leads electrically. The TAB 20 shown in FIG. 7 is equally spaced on the TAB tape continuously.

Next, according to an earlier development, an operation for the TAB handler when the IC chip is measured will be explained, as follows.

In FIG. 5, the TAB handler drives the sprocket to run the TAB tape including a plurality of TAB 20 in the rightward direction and stops the sprocket to stop the TAB 20 at a predetermined position.

Next, the TAB handler downs the pusher 2 so that the TAB 20 is contacted with the probe card 18. Thereafter, an IC tester connected to the probe card 18 and not shown in figures measures the IC chip 1.

When the IC tester judges that the IC chip 1 is a desired chip as a result of measuring, the TAB handler lifts the pusher 2. Thereafter, the TAB handler drives the sprocket to run the TAB tape including a plurality of TAB 20 in the rightward direction and stops the TAB tape. And after, the TAB handler downs the pusher 2 and the IC tester measures an IC chip of the next TAB 20.

On the other hand, when the IC tester judges that the IC chip 1 is an undesired chip as a result of measuring, the TAB handler lifts the pusher 2 and recognizes an image of the alignment mark 3 disposed on the TAB 20 to correct the relative position between the TAB 20 and the probe card 18. Thereafter, the TAB handler downs the pusher 2 so that the TAB 20 is contacted to the probe card 18. And after, the IC tester measures the IC chip 1 again.

When the IC tester judged that the IC chip 1 is a desired chip as a result of again measuring, the TAB handler lifts the pusher 2. Thereafter, the TAB handler drives the sprocket to run the TAB tape including a plurality of TAB 20 in the rightward direction and stops the TAB tape. And after, the TAB handler downs the pusher 2 and the IC tester measures an IC chip of the next TAB 20.

On the other hand, when the IC tester judges that the IC chip 1 is an undesired chip as a result of again measuring, the TAB handler sorts the TAB 20 into the undesired device at the following steps because the IC chip 1 on the TAB 20 is an undesired chip.

That is, in the case that the IC chip 1 is judged as an undesired chip at the first measurement, the cause may be an inadequate contact caused by the positional difference between the measurement probe needle 6 and the test pad 4. Therefore, the TAB handler is set beforehand so that the IC chip 1 is measured again after the relative position is corrected.

Therefore, in the case that the IC chip 1 is judged as an undesired chip at the second measurement, the TAB handler is set beforehand so that the IC chip 1 on the TAB 20 is sorted into an undesired chip.

However, according to the TAB 20 and the probe card 18 applied to the TAB handler according to an earlier development, in the case that the inadequate contact caused by the positional difference between the measurement probe needle 6 and the test pad 4 is the cause of being judged that the IC chip 1 is an undesired chip, the IC chip 1 on the TAB 20 is measured at two times.

In this case, a measuring time for measuring the IC chip 1 by the IC tester is about 1 second. Accordingly, there has been a problem that repeating the measurement causes the processing capability of the TAB handler to decrease.

### SUMMARY OF THE INVENTION

The present invention was developed in view of the above-described problems.

An object of the present invention is to provide a TAB, a probe card, a TAB handler and a method for measuring an IC chip which are more efficient by detecting a positional relation between the probe card and the TAB before measuring an IC chip on the TAB.

In accordance with one aspect of the present invention, a TAB (for example, a TAB 10 shown in FIG. 1) comprises: an IC chip (for example, an IC chip 1 shown in FIG. 1) formed on a tape-like film continuously; a test pad (for example, test pads 4A to 4H shown in FIG. 3) connected to the IC chip through a lead electrically; a perforation (for example, a perforation 12 shown in FIG. 3) for moving the tape-like film; an alignment mark (for example, an alignment mark 3 shown in FIGS. 1 and 3) for verifying a position of the test pad; and a pattern (for example, a positional verification pattern 5) for verifying a position of a probe card (for example, a probe card 9 shown in FIG. 1) on a TAB handler.

According to the TAB as described above, the TAB comprises: the IC chip formed on the tape-like film continuously; the test pad connected to the IC chip through the lead electrically; the perforation for moving the tape-like film; the alignment mark for verifying the position of the test pad; and the pattern for verifying the position of the probe card on the TAB handler.

Preferably, according to the TAB as described above, the pattern comprises two positional verification patterns (for example, positional verification pads 5A and 5B shown in FIG. 3) spaced at a predetermined interval and a line pattern (for example, a line pattern 11 shown in FIG. 3) connecting between two positional verification patterns.

In accordance with another aspect of the present invention, a probe card (for example, a probe card 9 shown in FIG. 1) for the TAB (for example, the TAB 10 shown in FIG. 1) as described above, comprises a plurality of measurement probe needles (for example, measurement probe needles 6A to 6H shown in FIG. 2) contactable with the test pad (for example, the test pads 4A to 4H shown in FIG. 3) of the TAB, and two positional verification probe needles (for example, positional verification probe needles 7A and 7B shown in FIG. 2) contactable with the positional verification patterns (for example, the positional verification pads 5A and 5B shown in FIG. 3) of the TAB.

According to the probe card described above, the probe card for the TAB as described above, comprises a plurality of measurement probe needles contactable with the test pad of the TAB, and two positional verification probe needles contactable with the positional verification patterns of the TAB.

In accordance with further aspect of the present invention, a TAB handler comprises: the probe card (for example, the probe card 9 shown in FIG. 1) for the TAB as described above; and a verifying member (for example, a detection circuit 15 shown in FIG. 4) for verifying whether the positional verification probe needles of the probe card are contacted with the positional verification patterns of the TAB, before measuring the IC chip on the TAB.

According to the TAB handler as described above, the TAB handler verifies whether the positional verification prove needles of the probe card are contacted with the positional verification patterns of the TAB, before measuring the IC chip on the TAB.

In accordance with further aspect of the present invention, a method for measuring an IC chip by the TAB handler further comprising a pusher (for example, a pusher 2 shown in FIG. 1), as described above, comprises the steps of: contacting the TAB with the probe card by the pusher of the TAB handler; judging whether the TAB is correctly contacted with the probe card; and measuring the IC chip on the TAB when it is judged that the TAB is correctly contacted with the probe card.

According to the method as described above, the TAB is contacted with the probe card by the pusher of the TAB handler; it is judged whether the TAB is correctly contacted with the probe card; and the IC chip on the TAB is measured when it is judged that the TAB is correctly contacted with the probe card.

Preferably, a method for measuring an IC chip as described above, further comprises the steps of: processing an image of the alignment mark on the TAB when it is judged that the TAB is not correctly contacted with the probe card; and correcting a relative position between the TAB and the probe card on the basis of a result of processing the image.

According to the method for measuring an IC chip as described above, the image of the alignment mark on the TAB is processed when it is judged that the TAB is not correctly contacted with the probe card; and the relative position between the TAB and the probe card is corrected on the basis of the result of processing the image.

Therefore, when the positional verification probe needles of the probe card are contacted with the positional verification patterns on the TAB, they are continued to each other. Accordingly, it is possible to verify the relative position between the probe card and the TAB before measuring the IC chip on the TAB. Consequently, it is possible to reduce a dead measuring time caused by an inadequate contact between the measurement probe needles and the test pads when measuring an IC chip, so that it is possible to select an IC chip efficiently.

### BRIEF DESCRIPTION OF THE DRAWINGS

The present invention will become more fully understood from the detailed description given hereinafter and the accompanying drawings which are given by way of illustration only, and thus are not intended as a definition of the limits of the present invention, and wherein:

FIG. 1 is a sectional view showing a structure of a TAB handler and a TAB 10 according to an embodiment of the present invention;

FIG. 2 is a plan view of a probe card 9 shown in FIG.

FIG. 3 is a plan view of the TAB 10 shown in FIG. 1;

FIG. 4 is a circuit diagram of a detection circuit 15 connected to positional verification probe needles 7A and 7B shown in FIG. 2, for detecting a contact position between the TAB 10 and the probe card 9;

FIG. 5 is a sectional view showing a structure of a TAB handler and a TAB 20 according to an earlier development;

FIG. 6 is a plan view of a probe card 18 shown in FIG. 5; and

FIG. 7 is a plan view of the TAB 20 shown in FIG. 5.

### PREFERRED EMBODIMENT OF THE INVENTION

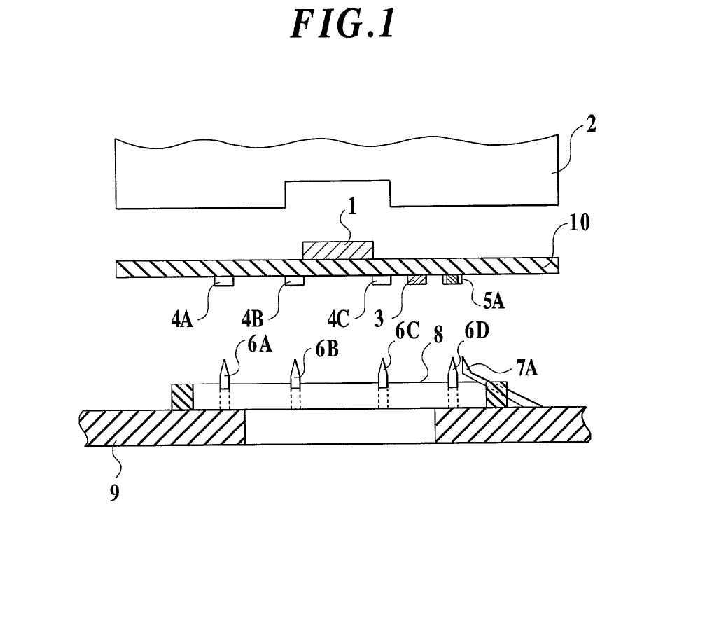

Hereinafter, an embodiment of a TAB, a probe card and a TAB handler of the present invention will be explained with reference to FIGS. 1 to 4, in detail.

First, the structure of the TAB and the probe card applied to the TAB handler will be explained, as follows.

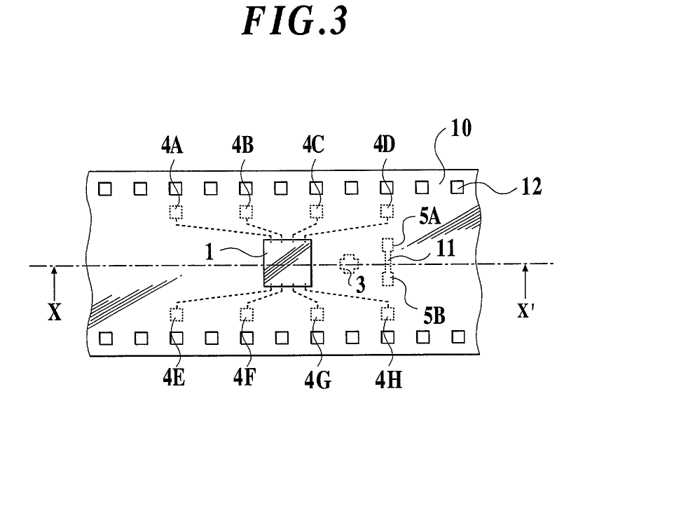

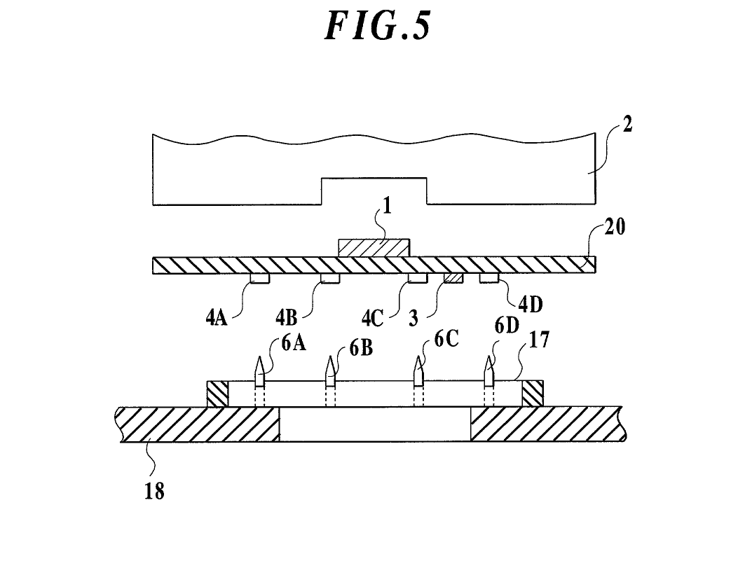

FIG. 1 is a sectional view showing the structure of the TAB handler and the TAB 10 according to an embodiment of the present invention. In more detail, according to the TAB 10, FIG. 1 is a sectional view taken substantially along the lines X-X′ of FIG. 3. In FIG. 1, the same reference numerals are attached to the same elements as one in FIG. 5.

In FIG. 1, the TAB handler comprises a pusher 2 and a probe card 9. The TAB 10 is disposed between the pusher 2 and the probe card 9. The pusher 2 holds the TAB 10 and presses it against the probe card 9.

On a front surface of the TAB 10, an IC chip 1 is mounted. On a rear surface of the TAB 10, an alignment mark 3, a plurality of test pads 4 (for example, test pads 4A to 4C shown in FIG. 1) and a positional verification pattern 5 (for example, a positional verification pad 5A of the positional verification pattern 5 shown in FIG. 1) to the probe card 9 are formed.

Further, on the probe card 9, a measurement probe needle 6 (for example, measurement probe needles 6A to 6D shown in FIG. 1) as a needle to the TAB 10 and a positional verification probe needle 7 (for example, a positional verification probe needle 7A shown in FIG. 1) as a needle to the positional verification pattern 5 (for example, the positional verification pad 5A shown in FIG. 1) of the TAB 10 are disposed.

In FIG. 1, free edge portions (portions at the side of the TAB 10 in FIG. 1) of the measurement probe needles 6A to 6D can be contacted with the test pads 4A to 4D, respectively. And fixed edge portions (portions at the side of the probe card 9 in FIG. 1) of the measurement probe needles 6A to 6D are held on the probe card 9 by a bonding block 8. Like the measurement probe needles 6A to 6D, a free edge portion of the positional verification probe needle 7A can be contacted with the positional verification pad 5A and a fixed edge portion is held on the probe card 9 by the bonding block 8.

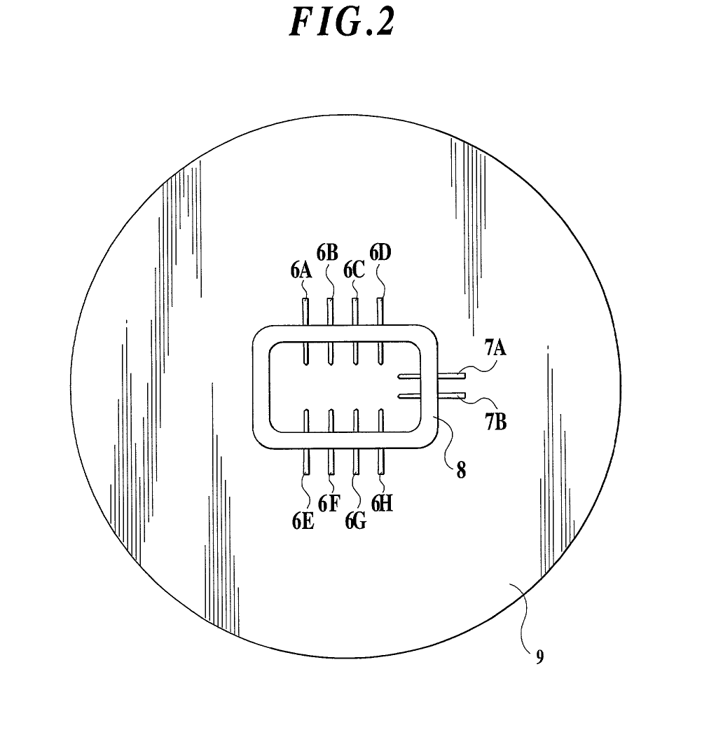

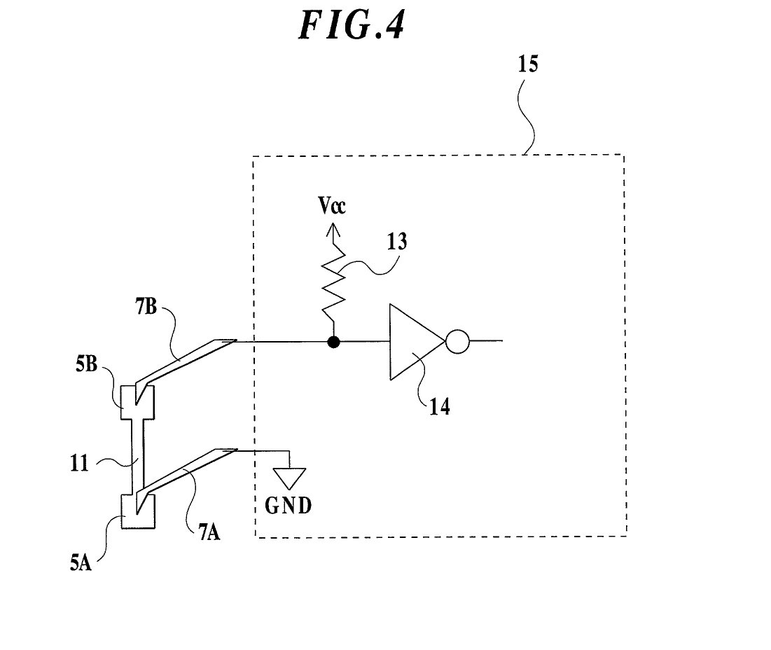

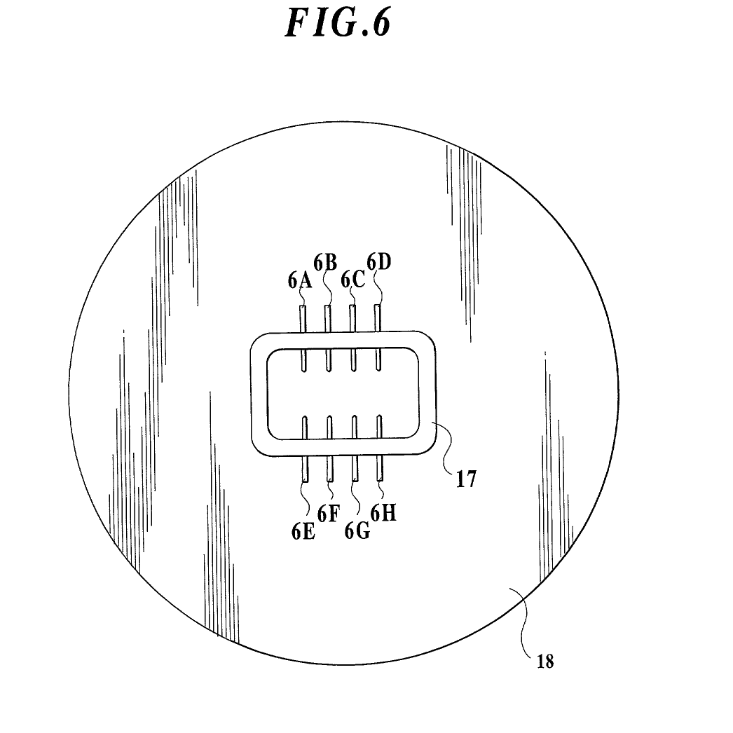

FIG. 2 is a plan view of the probe card 9 shown in FIG. 1. In FIG. 2, the probe card 9 is one that is the positional verification probe needles 7A and 7B are additionally disposed on the probe card 18 shown in FIG. 6. Further, like the probe card 18, under the free edge portions of the measurement probe needles 6A to 6H and the positional verification probe needles 7A and 7B (an inside of the bonding card 8), an opening portion through which an image of the alignment mark 3 can be recognized is formed. The positional verification probe needles 7A and 7B are connected to the following detection circuit 15 shown in FIG. 4.

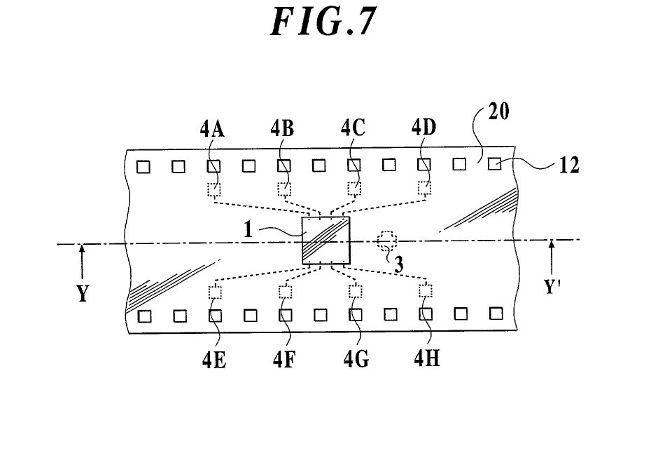

FIG. 3 is a plan view of the TAB 10 shown in FIG. 1. In FIG. 3, the TAB 10 is one that is the positional verification pattern 5 (the positional verification pads 5A and 5B and the line pattern 11) is additionally disposed on the TAB 20 shown in FIG. 7. The positional verification pattern 5 is composed of the positional verification pads 5A and 5B as a pad of the pattern and a line pattern 11 for connecting between the positional verification pads 5A and 5B.

The positional verification pads 5A and 5B are spaced at a predetermined interval, and can contact with the free edged portions of the positional verification probe needles 7A and 7B as a probe needle, respectively, shown in FIG. 2. That is, the positional verification probe needles 7A and 7B are disposed correspondingly to the positional verification pads 5A and 5B, respectively. Therefore, in FIG. 1, if the measurement probe needle 6 is correctly contacted to the test pad 4, the positional verification probe needle 7 is inevitably contacted to the positional verification pattern 5. Accordingly, the positional verification probe needles 7A and 7B are electrically continued to each other.

Next, the detection circuit 15 for electrically detecting the contact position between the test pad 4 and the measurement probe needle 6 will be explained with reference to FIG. 4. FIG. 4 is a circuit diagram of the detection circuit 15 connected to the positional verification probe needles 7A and 7B shown in FIG. 2, for detecting the contact position between the TAB 10 and the probe card 9.

In FIG. 4, the detection circuit 15 is composed of a register 13 and an inverting circuit 14. As shown in FIG. 4, one terminal of the register 13 and an input side of the inverting circuit 14 are connected to the positional verification probe needle 7B, and the ground of the detection circuit 15 is connected to the positional verification probe needle 7A. Further, the other terminal of the register 13 is connected to an input voltage Vcc.

In the case that the pusher 2 presses the TAB 10 against the probe card 9 at a predetermined contact position, the positional verification probe needles 7A and 7B are continued to each other through the detection circuit 15 because the position verification pads 5A and 5B are connected to each other through the line pattern 11.

In the case that the positional verification probe needles 7A and 7B are correctly connected to the positional verification pads 5A and 5B, respectively, the positional verification probe needles 7A and 7B are continued to each other through the detection circuit 15, so that the inverting circuit 14 outputs a high (H) state.

On the other hand, in the case that the positional verification probe needles 7A and 7B are not correctly connected to the positional verification pads 5A and 5B, respectively, the inverting circuit 14 outputs a low (L) state.

That is, according to the TAB handler, it is possible to verify whether the measurement probe needle 6 is correctly contacted with the test pad 4 of the TAB 10 or not, by detecting the output from the inverting circuit 14.

Next, according to an embodiment of the present invention, an operating for the TAB handler when the IC chip 1 is measured will be explained, as follows.

In FIG. 1, the TAB handler drives the sprocket to run the TAB tape including a plurality of TAB 10 in the rightward direction and stops the sprocket to stop the TAB tape at a predetermined position.

Next, the TAB handler downs the pusher 2 so that the TAB 10 is contacted with the probe card 9. Thereafter, the IC tester connected to the probe card 9 and not shown in figures measures the IC chip 1.

The detection circuit 15 shown in FIG. 4 outputs a detection signal of “H” or “L” to a CPU not shown in figures, of the TAB handler, according to the contact state between the positional verification pads 5A and 5B of the TAB 10 and the positional verification probe needles 7A and 7B of the probe card 9. The CPU judges the contact state between the test pad 4 of the TAB 10 and the measurement probe needle 6 of the probe card 9, by the detection signal outputted from the detection circuit 15.

When the CPU judges that the measurement probe needle 6 is correctly contacted with the test pad 4, the TAB handler measures the IC chip 1 by the IC tester connected to the probe card 9.

When the CPU judges that the measurement probe needle 6 is inadequately contacted with the test pad 4, the TAB handler lifts the pusher 2 and recognizes an image of the alignment mark 3. Thereby, the TAB handler corrects the relative position between the TAB 10 and the probe card 9. And thereafter, the TAB handler downs the pusher 2 so that the TAB 10 is contacted with the probe card 9. Therefore, the CPU judges the contact state between the test pad 4 of the TAB 10 and the measurement probe needle 6 of the probe card 9 by the detection signal outputted from the detection circuit 15, again. Next, the TAB handler instructs the IC tester to measure the IC chip 1.

According to the measurement as described above, in the case that the IC tester judges that the IC chip 1 on the TAB 10 is a desired chip, the TAB handler lifts the pusher 2. Next, the TAB handler drives the sprocket to run the TAB tape and stops the sprocket to stop the TAB tape, and after the TAB handler downs the pusher 2 to measure the IC chip 1 on the next TAB 10.

On the other hand, according to the measurement as described above, in the case that the IC tester judged that the IC chip 1 on the TAB 10 is an undesired chip, the TAB 10 is sorted as an undesired device at the next step.

According to the TAB 10 as described above, the TAB 10 comprises: the IC chip 1 formed on the tape-like film continuously; the test pads 4A to 4H connected to the IC chip through the leads electrically; the perforation 12 for moving the tape-like film; the alignment mark 3 for verifying the position of the test pad; the positional verification pattern 5 comprising two positional verification patterns 5A and 5B spaced at the predetermined interval and the line pattern 11 connecting between two positional verification patterns, for verifying the position of the probe card 9 on the TAB handler.

According to the present invention, a main effect can be obtained, as follows.

When the positional verification probe needles of the probe card are contacted with the positional verification patterns on the TAB, they are continued to each other. Accordingly, it is possible to verify the relative position between the probe card and the TAB before measuring the IC chip on the TAB. Consequently, it is possible to reduce a dead measuring time caused by an inadequate contact between the measurement probe needles and the test pads when measuring an IC chip, so that it is possible to select an IC chip efficiently.

Although the present invention has been explained according to the above-described embodiment, it should also be understood that the present invention is not limited to the embodiment and various changes and modifications may be made to the invention without departing from the gist thereof.

For example, although eight test pads 4A to 4H, two positional verification pads 5A and 5B, and two positional verification probe needles 7A and 7B are shown in figures, the number thereof is not limited to the embodiment as described above. For example, four or eight positional verification pads 5 may be disposed on the TAB 10 and four or eight positional verification prove needles 7 may be disposed at the probe card 9.

The entire disclosure of Japanese Patent Application No. Tokugan-hei 11-365158 filed on Dec. 22, 1999 including specification, claims, drawings and summary are A incorporated herein by reference in its entirety.

What is claimed is:

1. A TAB comprising:
an IC chip formed on a tape-like film continuously;
a test pad connected to the IC chip through a lead electrically;
a perforation for moving the tape-like film;
an alignment mark for verifying a position of the test pad; and
a pattern for verifying a position of a probe card on a TAB handler.

2. A TAB according to claim 1:
wherein the pattern comprises two positional verification patterns spaced at a predetermined interval and a line pattern connecting between two positional verification patterns.

3. A probe card for a TAB, the TAB comprising: an IC chip formed on a tape-like film continuously; a test pad connected to the IC chip through a lead electrically; a perforation for moving the tape-like film; an alignment mark for verifying a position of the test pad; and a pattern comprising two positional verification patterns spaced at a predetermined interval and a line pattern connecting between two positional verification patterns, for verifying a position of the probe card;
wherein the probe card comprises a plurality of measurement probe needles contactable with the test pad of the TAB, and two positional verification probe needles contactable with the positional verification patterns of the TAB.

4. A TAB handler comprising:
a probe card for a TAB, the TAB comprising: an IC chip formed on a tape-like film continuously; a test pad connected to the IC chip through a lead electrically; a perforation for moving the tape-like film; an alignment mark for verifying a position of the test pad; and a pattern comprising two positional verification patterns spaced at a predetermined interval and a line pattern connecting between two positional verification patterns, for verifying a position of the probe card; wherein the probe card comprises a plurality of measurement probe needles contactable with the test pad of the TAB, and two positional verification probe needles contactable with the positional verification patterns of the TAB; and
a verifying member for verifying whether the positional verification probe needles of the probe card are contacted with the positional verification patterns of the TAB, before measuring the IC chip on the TAB.

5. A method for measuring an IC chip by a TAB handler, the TAB handler comprising:
a probe card for a TAB, the TAB comprising: an IC chip formed on a tape-like film continuously; a test pad connected to the IC chip through a lead electrically; a perforation for moving the tape-like film; an alignment mark for verifying a position of the test pad; and a pattern comprising two positional verification patterns spaced at a predetermined interval and a line pattern connecting between two positional verification patterns, for verifying a position of the probe card; wherein the probe card comprises a plurality of measurement probe needles contactable with the test pad of the TAB, and two positional verification probe needles contactable with the positional verification patterns of the TAB;
a verifying member for verifying whether the positional verification probe needles of the probe card are contacted with the positional verification patterns of the TAB, before measuring the IC chip on the TAB; and
a pusher;
wherein the method comprises the steps of: contacting the TAB with the probe card by the pusher of the TAB handler; judging whether the TAB is correctly contacted with the probe card; and measuring the IC chip on the TAB when it is judged that the TAB is correctly contacted with the probe card.

6. A method for measuring an IC chip according to claim 5, further comprising the steps of:
processing an image of the alignment mark on the TAB when it is judged that the TAB is not correctly contacted with the probe card; and
correcting a relative position between the TAB and the probe card on the basis of a result of processing the image.
